(19) United States
(12) Patent Application Publication
(10) Pub. No.: US 2010/0019564 A1
(43) Pub. Date: Jan. 28, 2010

(54) WHEEL WOUND FROM FIBER-REINFORCED PLASTIC AND METHOD FOR ITS PRODUCTION

(76) Inventor: Arwed Theuer, Zorbig (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/447,819

(22) PCT Filed: Oct. 15, 2007
(86) PCT No.: PCT/EP07/60972

§ 371 Date: Apr. 29, 2009

(30) Foreign Application Priority Data
Oct. 31, 2006 (DE) 102006051867.5

(51) Int. Cl. B60B 5/02

(52) U.S. Cl. 301/64.703

(57) ABSTRACT

The present invention relates to a wheel (1) wound from fiber-reinforced plastic having a wheel spider (2) and a rim well (3). Here, it is essential to the invention that a plurality of rings (4) which bear against one another and are connected to one another in a common surface form the wheel spider (2), wherein the wheel spider (2) and the rim well (3) have synthetic-resin-impregnated, wound carbon fibers and are cohesively connected to one another.

The present invention relates to a wheel which is wound from fibre-reinforced plastic according to the preamble of Claim 1. The invention also relates to a method for producing a wheel according to the preamble of Claim 11 or 12.

The use of carbon-fibre-reinforced plastics is gaining in importance. Examples of these can be the helmets for cyclists and motorcyclists and for horse-riders which are produced from these materials. However, car parts for body and chassis, as well as components which are exposed to high mechanical loads during use in space technology and aeroplane manufacture, are also produced from carbon-fibre-reinforced plastics.

DE 101 45 630 A1 discloses a built wheel consisting of fibre composite material, in which the individual parts of the wheel spider and the rim are manufactured from unidirectional endless fibre strands in combination with a cast resin method, with winding taking place about a core and additionally radial fibre windings being applied with the wheel spider elements (disc form). A weave—consisting of undirected endless fibre strands—is additionally applied cohesively to the outwardly facing side of the wheel spider elements. The wheel spider elements which are prepared in this manner are then fastened to webs of the wheel rim, with a hub which consists of metal or plastic also previously being inserted centrally. It may be doubted whether this design of the disc-shaped wheel spider elements with the connection to the rim ring would withstand the overlapping tensile, compressive and torsional loads during operation on a vehicle. Effective cornering forces would lead to the narrow bearing faces between the wheel spider elements on one side and the rim ring and the hub on the other side being loosened.

DE 35 41 074 A1 discloses a wheel rim consisting of fibre-reinforced plastic which is produced by means of a specific method. The wheel rim and the web which supports it laterally at a defined angle consist of a plurality of layers of wound fibre segments, which have alternately axial and radial fibre orientations. The rim ring and the rim web obtain their shape by profiling in the course of pressing/stamping from a starting material which is produced flat and are then joined together before curing. The wheel to be produced in this manner for use on motor vehicles requires a high outlay on manufacturing technology, which is not least manifested in the provision of complicated winding machines and pressing/stamping dies. The production of the two segments to be produced by winding and pressing/stamping and joining them together is technologically laborious and therefore expensive.

DE 38 14 343 discloses a rail wheel which is joined together from segments of the hollow cassette type. Disadvantageously, a foam filling is used as the winding core, which remains in the wheel after manufacture. The structure is not suitable for connection of a rim well and is thus only suitable for rail wheels.

EP 0 539 214 B1 describes a motor vehicle wheel frame, the shape of which is formed in each case by two half shells both in the region of the spokes and in the region of the rim well. Disadvantageously, hollow cross sections are produced in this case, which cannot be inspected internally in the event of possible interlaminary damage.

The present invention is concerned with the problem of specifying for a wheel of the generic type an improved or at least a different embodiment which is characterised in particular by a high mechanical load capacity.

This problem is solved according to the invention by the subject matter of the independent claims. Advantageous embodiments form the subject matter of the dependent claims.

The invention is based on the general idea of configuring a wheel which is wound from fibre-reinforced plastic in a segmented manner and in such a manner that a plurality of rings which are connected to each other form a wheel spider and are connected securely to a rim well which radially surrounds the wheel spider. The rings which are connected to each other bear against each other in a common plane and together form the wheel spider. Both the wheel spider and the rim well have synthetic-resin-impregnated, wound carbon fibres and are furthermore cohesively connected to each other. This conceptually new structure means that a wheel can be created which on the one hand is light owing to the material used and on the other hand withstands high mechanical loads even over a relatively long time owing to the materials used, such as the carbon fibres and synthetic resin. The use of such a wheel is therefore interesting in particular for motor sport, as in this case a low weight on the one hand and a high mechanical load capacity on the other hand are to be achieved.

Expediently, radially outwardly facing parts of the rings form a part of the rim well, while radially inwardly facing parts of the rings form a part of a wheel hub. Furthermore, parts of the rings which face each other form spokes of the wheel spider. The rings are thus preferably configured as circular flat segments which cover an angle region of greater or lesser size depending on the number of desired spokes. In the case of rings which cover a relatively small circular area, more spokes are necessarily produced than in the case of rings which cover a relatively large circular area. As the rings which form the wheel spider are normally configured the same, a wheel spider is normally always produced without any imbalance. The possibility of designing the rings individually means that a possible design of the wheel can be influenced in virtually any desired manner, as a result of which a higher level of design freedom is produced.

In an advantageous embodiment of the solution according to the invention, the rings and the rim well in each case have a solid profile cross section. Solid profile cross sections have the great advantage compared to hollow cross sections that there are no hollow spaces which are difficult or impossible to check and make maintenance or safety inspections difficult. At the same time the production of the rings and of the rim well is much easier with solid profile cross sections than production with hollow cross sections, with which a winding core is additionally needed, which may have to be removed later.

In a further advantageous embodiment of the solution according to the invention, the rings of the wheel spider together with the rim well form a frame support structure. Frame support structures offer a high degree of rigidity with a low weight, which is also known in particular from other constructive fields such as bridge or aeroplane construction.

Further important features and advantages of the invention can be found in the subclaims, the drawings and the associated description of the figures using the drawings.

It is self-evident that the features which are mentioned above and those which are still to be explained below can be used not only in the combination specified in each case, but also in other combinations or alone without departing from the framework of the present invention.

Preferred exemplary embodiments of the invention are shown in the drawings and are explained in more detail in the following description, with the same reference symbols referring to the same or similar or functionally identical components.

In the figures,

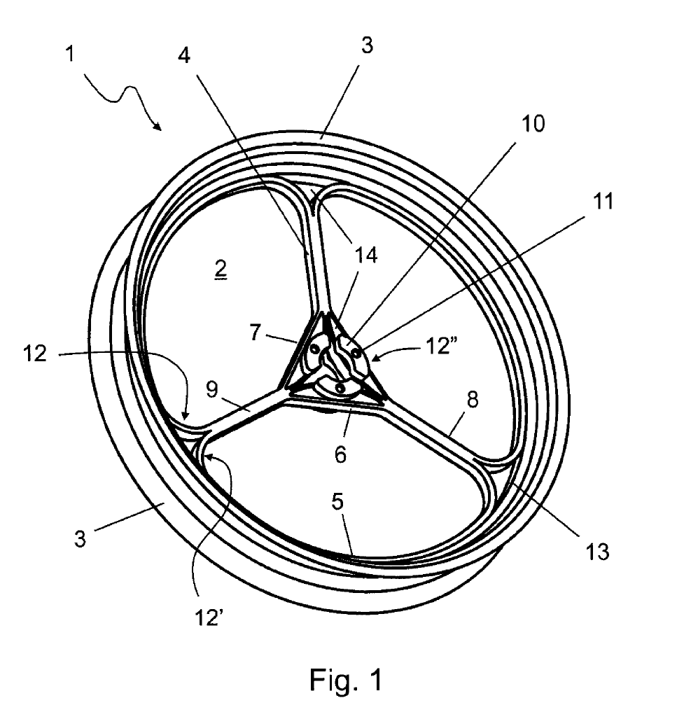

FIG. 1 shows schematically a wound wheel according to the invention for a motorcycle with three rings which bear against each other in a common plane and are connected to each other,

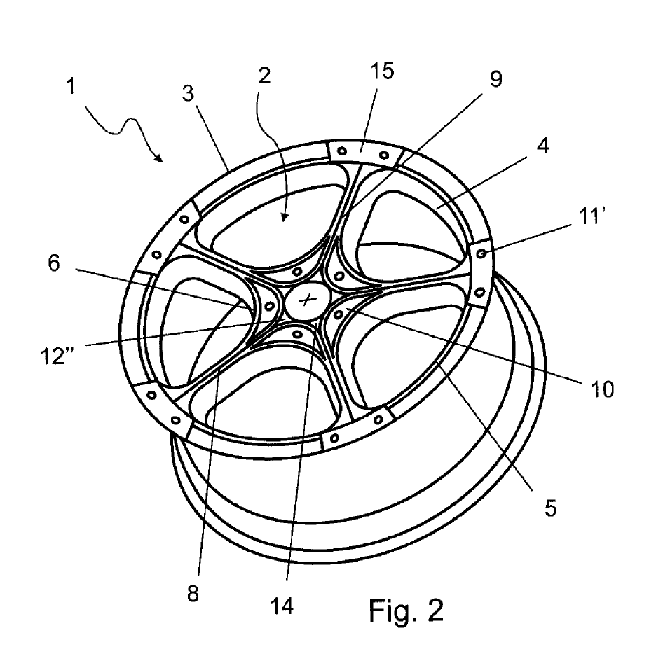

FIG. 2 schematically shows an illustration as in FIG. 1, but for a wheel according to the invention for a passenger car, which has five rings and a rim well,

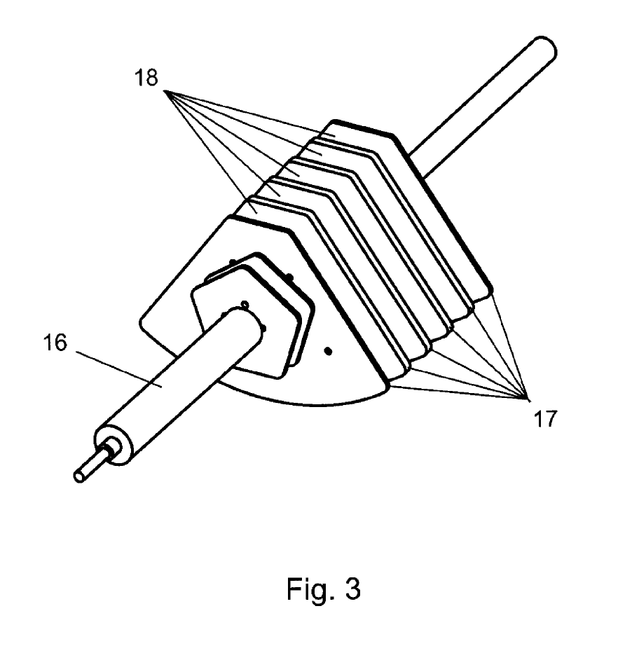

FIG. 3 schematically shows a shaft, which is equipped with winding cores, of a winding machine for producing the rings of a wheel spider,

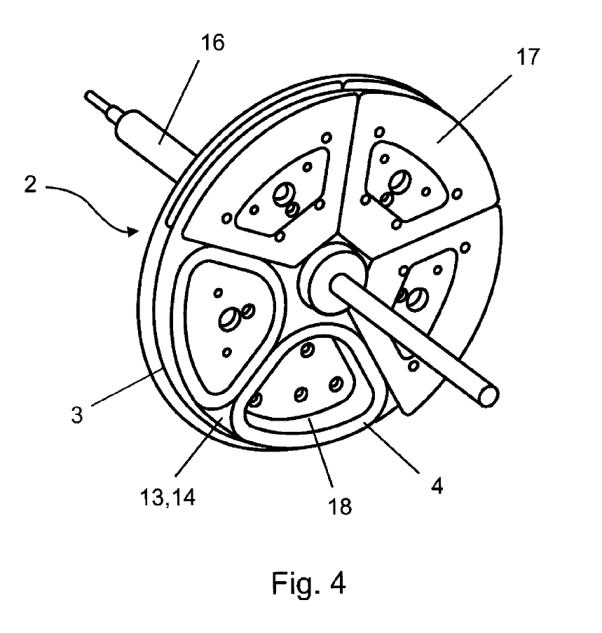

FIG. 4 schematically shows a centring device for curing the rings of the wheel spider, which bear against each other in a common plane and are connected to each other,

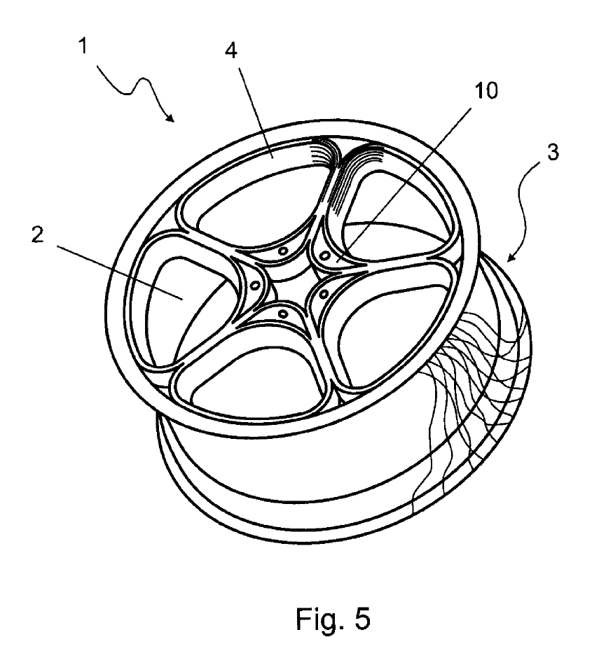

FIG. 5 schematically shows an illustration as in FIG. 2, but in a different embodiment.

In accordance with FIG. 1, a wheel 1 according to the invention which is wound from fibre-reinforced plastic has a wheel spider 2 and a rim well 3. A plurality of, in this case a total of three, rings 4 which bear against each other in a common plane and are connected to each other form the wheel spider 2. The rings 4 and the rim well 3 furthermore have preferably synthetic-resin-impregnated wound carbon fibres, with the rings 4 being connected cohesively among themselves to form the wheel spider 2 and together to the rim well 3.

Depending on the embodiment of the wheel 1 according to the invention, for example as a wheel 1 for a motorcycle, as shown in FIG. 1, or as a wheel 1 for a passenger car, as shown in FIG. 2, different numbers of rings 4 can form the wheel spider 2. Common to all the embodiments is however that radially outwardly facing parts 5 of the rings 4 form a part of the rim well 3, while radially inwardly facing parts 6 of the rings 4 can form a part of a hub. Parts 8, which face each other, of the rings 4 in turn form spokes 9 of the wheel spider 2. A number of the spokes 9 is dependent on an angular extent of the individual rings 4, so that with an angular extent of the rings 4 of 120°, as shown in FIG. 1, a total of three spokes 9 is produced, whereas with an angular extent of the rings 4 of 72°, as in FIG. 2, a total of five spokes 9 is produced. The virtually freely selectable angular extent of the rings 4 allows a high degree of design freedom. If an angular extent of 60° of the individual rings 4 is selected, they can be configured essentially as equilateral triangles, with each ring 4 usually having a continuous, rectangular, square, trapezoid or other cross section without interruption of a fibre orientation in the unidirectionally wound fibre roving (cf. FIG. 5). In contrast, the fibre roving used in the rim well 3 can have a multi-directional fibre orientation. This means that in particular loads which act tangentially, radially and as torsional forces can be very well absorbed and transmitted. With the preferably used embodiments, the individual rings 4 are connected permanently to each other and preferably likewise permanently to the rim well 3.

The radially inwardly facing parts 6 of the rings 4 have in each case at least one wound in metal insert 10 which for example can be provided in each case with at least one through-opening 11 for a wheel bolt. The wheel 1 according to the invention can be fastened to a motorcycle or a passenger car by means of these through-openings 11. The metal insert 10 can have for example a sickle-shaped design, as shown in FIG. 2, and for example be configured from light metal or steel, with the metal insert 10 being integrated securely in the ring 4 by means of individual fibre rovings. The wheel spider 2 can generally be combined with the rim well 3 by applying a rim well 3 which is likewise wound or can be wound from long carbon fibres to the wheel spider 2 which is not yet cured and curing both components together. In a specific embodiment it is also conceivable to combine an at least partially metallic rim well 3 with the wheel spider 2 which consists of wound carbon fibres, with bearing faces 15 being provided for this purpose on an internal diameter of the at least partially metallic rim well 3 with corresponding screw-fastening holes or through-openings 11′. In this case the wheel spider 2 can bear laterally against the bearing faces 15 and be screw-fastened to them.

Owing to the fact that the rings 4, which are the same in all the wheels 1, bear against each other in a common plane and are connected to each other, they have an essentially triangular shape, with the rings 4 having a preferably rounded configuration in their corner regions 12. For additional reinforcement of the wheel 1 according to the invention, webs 13, which run in the circumferential direction of the wheel 1, can be provided in the radially outer corner regions 12′ between two adjacent rings 4 and are for example integrated into a fibre weave which reinforces the rim well 3 and are preferably configured in metal or plastic. In contrast, there are embedded in the radially interior corner regions 12″ of the rings 4 above-mentioned metal inserts 10, which are used to fasten the wheel 1 to the vehicle and in particular as a receptacle 7 for a wheel hub (not shown). Remaining interspaces 14 between the corner regions 12 can be cast with synthetic resin, with it being possible in particular for the interspaces 14 in the radially interior corner regions 121″ of the rings 4 to be moulded with synthetic resin. Furthermore, it can be provided for at least some of the metal inserts 10 to project outwards from an outer side which is visible when the wheel 1 is mounted on the vehicle and to have a contour which faces towards the outer side for fastening a wheel and/or decorative cap (not shown).

A possible method for producing a wheel 1 from fibre-reinforced plastic is to be explained briefly below:

According to FIG. 3, a plurality of winding cores 18 which are sectioned off in the axial direction of the shaft 16 by dividing walls 17 are placed on a shaft 16 of a winding machine, the rest of which is not shown, over which winding cores a plurality of layers of synthetic-resin-impregnated long carbon fibres are wound in a preferably unidirectional manner. It is provided for in particular sickle-shaped metal inserts 10 to be integrated at the radially interior corner regions 12″ of the rings 4 during the winding. If the winding has achieved a web width or cross-sectional thickness of the rings which is sufficient for the loading which occurs later, the rings in their not yet cured state are placed into a centring device (cf. FIG. 4) and clamped so that in each case the parts 8 which bear against each other of the adjacent rings 4 are pressed against each other until air drying or an artificial heat supply which is suitable for the respective plastic has carried out a complete curing process. The dimensional stability of the rings which are placed in the centring device is ensured by the above-mentioned winding cores 18. The wheel spider 2 which is produced in this manner is then removed from the centring device and connected in a form-fitting manner for example to a rim well 3 which is metallic or likewise produced from synthetic-resin-impregnated long carbon fibres. For the latter rim well 3, the centring device is clamped into a combined winding machine (not shown) and, after placing of lateral plates which are formed in correspondence with a rim well 3 on the circumference of the wheel spider 2 which is clamped in the centring device, the rim well 3 is wound onto the outer parts 5 of the rings 4. In order to increase the strength and stability of the connection between the rim well 3 to be wound on and the wheel spider 2, webs 13 are placed in the circumferential direction in the interspaces 14 of the parts 5 which face radially outwards, which webs are preferably integrated completely and securely in the wound up fibre rovings. After the forming of the rim well 3 is completed, the rim well 3 and the wheel spider 2 are cured together in the centring device.

It is also conceivable for the wheel 1 to be wound completely dry according to what is known as the RTM method and then for synthetic resin to be pressed into the wound fibre layers in a closed mould. The subsequent curing takes place as mentioned above according to the atmosphere or under the influence of heat.

When an at least partially metallic rim well 3 is used, it is connected to the wheel spider 2 in such a manner that the wheel spider 2 bears against bearing faces 15 which are formed correspondingly on the rim well 3 and they are screw-fastened securely to each other by means of aligning through-openings 11′ in the bearing faces 15 and in the wheel spider 2. When producing the wheel spider 2 it can also be provided for a carbon fibre weave band or a formed fibre body which is woven or braided in a closed mould to be placed in a positive mould and cast with synthetic resin. The carbon fibre weave band is placed in the mould in such a manner with regard to its fibre orientation that diameters in the rim well 3 which are different owing to a shear effect can preferably be compensated.

It can also generally be provided for the wound wheel 1 to be given an attractive appearance with a visually effective paint coating, with the paint at the same time providing protection from mechanical damage. When very small winding cores 18 are used, the wheel spider 2 can be designed with regard to its joined rings 4 as a roll. Furthermore, it is also conceivable for a wheel flange (not shown) to be wound on instead of the rim well 3, and for such a wheel 1 to be used on rail vehicles.

In particular in non-motorised vehicles such as a golf caddy, wheels (1) can also be conceivable which have other fibre materials such as wood and/or glass fibres in addition to carbon fibres. In this case the same consideration in principle applies as in the carbon wheels, according to which the fibre direction runs essentially parallel to the main load direction in the wheel, that is, preferably in the radial direction. The inclusion of other materials means that what are known as hybrid materials are produced, which allow a design which can be shaped individually in addition to improved strength properties. The production of such wheels which are manufactured from hybrid material takes place in a similar manner to the production of the carbon-fibre-reinforced wheels, with individual fibre layers being connected to each other, in particular laminated or glued or adhesively bonded to each other, during or after laying/winding.

1. A wheel wound from fibre-reinforced plastic, comprising:
a wheel spider;
a rim well, and
a plurality of rings which bear against each other in a common plane and are connected to each other to form the wheel spider,
wherein the wheel spider and the rim well have synthetic-resin-impregnated, wound carbon fibres and are cohesively connected to each other.

2. A wheel according to claim 1, wherein radially outwardly facing parts of the rings form a part of the rim well, radially inwardly facing parts of the rings form a part of a hub, and parts which face each other at the rings form spokes of the wheel spider.

3. A wheel according to claim 2, wherein the radially inwardly facing parts of the rings in each case have at least one wound in metal insert.

4. A wheel according to claim 1, where, in order to produce the rings, winding cores constructed at least in part from metal and plastic are provided, which are removed after the synthetic resin is cured.

5. A wheel according to claim 1, wherein the rings together with the rim well form a frame support structure, the frame support structure configured to absorb loads in a frame support structure plane in a direction that is at least one of orthogonal and oblique thereto.

6. A wheel according to claim 1, wherein the rings and the rim well in each case have a solid profile cross section.

7. A wheel according to claim 1, wherein at least the rings have unidirectionally wound fibre rovings.

8. A wheel according to claim 1, wherein the rings have a triangular shape with rounded corner regions, and
webs which run in a circumferential direction of the wheel are provided in radially outer corner regions between two adjacent rings,
wherein the webs are integrated into a fibre weave which reinforces the rim well.

9. A wheel according to claim 8, wherein metal inserts are embedded in radially interior corner regions of the rings, where the metal inserts have at least one through-opening for a wheel bolt.

10. A wheel according to claim 9, wherein at least some of the metal inserts project from the wheel spider in the vicinity of a hub on an outer side of the wheel, which is visible when the wheel is mounted, and have a contour which faces the outer side for fastening one of a decorative cap and an axle stub cover.

11. A method for producing a wound wheel including a fibre-reinforced plastic, a wheel spider and a rim well, comprising:
producing a plurality of rings by winding synthetic-resin-impregnated carbon fibres around winding cores,
placing the rings that are not yet cured in a centring device,
applying a radial compression force,
joining the rings at their lateral faces which touch each other,
placing webs in a circumferential direction in interspaces on outwardly facing, rounded corner regions of the rings,
applying mould plates for subsequently forming an outer contour, and
winding the rim well onto the wheel spider before curing the wheel spider, thereby cohesively connecting the rim well to the wheel spider.

12. A method for producing a wound wheel, including a wheel spider which has a plurality of rings which bear against each other in a common plane and are connected to each other and are constructed of synthetic-resin-impregnated, wound carbon fibres, and a metal based rim well, comprising:
is connecting the wheel spider in a cured state in a force-fitting and form-fitting manner to the metal based rim well by means of bearing faces and through-openings introduced therein.

13. A method according to claim 11, further comprising the step of producing the rings on a shaft of a winding machine such that they are separated from each other by dividing walls.

14. A method according claim 12, wherein the rings have a triangular shape with rounded corner regions, wherein metal inserts are wound in radially interior corner regions between two rings and interspaces are cast with synthetic resin in order to form a hub.

15. (canceled)

16. A method according to claim 12, wherein one of a carbon fibre weave band and a formed fibre body which is one of woven and braided in a closed mould is placed in a positive mould and cast with synthetic resin.

17. A method according to claim 16, wherein the selected carbon fibre weave band is placed in the positive mould in such that with regard to a fibre orientation of the carbon fibre weave band that diameters in the rim well which are different owing to a shear effect are compensated.

18. A method according to claim 11, further comprising the step of producing the rings on a shaft of a winding machine such that they are separated from each other by dividing walls.

19. A method according claim 11, wherein the rings have a triangular shape with rounded corner regions, wherein metal inserts are wound in radially interior corner regions between two rings and interspaces are cast with synthetic resin in order to form a hub.

20. A method according to claim 11, wherein one of a carbon fibre weave band and a formed fibre body which is one of woven and braided in a closed mould is placed in a positive mould and cast with synthetic resin.

21. A method according to one of claim 11, where, in order to produce at least the wheel spider, dry-wound long carbon fibres are used, wherein at least the wheel spider is impregnated with synthetic resin under pressure in a closed mould after the step of winding is complete.
